(19) United States
(12) Patent Application Publication
(10) Pub. No.: US 2025/0196598 A1
(43) Pub. Date: Jun. 19, 2025

(54) VEHICLE ROOF COMPRISING A WIND DEFLECTOR DEVICE

(71) Applicant: Webasto SE, Stockdorf (DE)

(72) Inventors: Gregoire PIROUX, Stockdorf (DE); Manfred WIMMER, Stockdorf (DE)

(21) Appl. No.: 18/965,307

(22) Filed: Dec. 2, 2024

(30) Foreign Application Priority Data
Dec. 14, 2023 (DE) 10 2023 135 240.7

(51) Int. Cl. B60J 7/22

(52) U.S. Cl. CPC B60J 7/22

(57) ABSTRACT

A vehicle roof having an exposable roof opening and having a wind deflector device, assigned to the roof opening, which has a wind deflector bracket having lateral bearing arms and a respective deployment means that includes one of the two bearing arms, the deployment means being pivotably carried on a pivot bearing means located on the roof and carrying the wind deflector bracket for pivoting between a pivoted-down non-operated position and a pivoted-out operated position. The pivot bearing means has a bearing component on which the deployment means is carried, the bearing component is arranged on a roof component and is fitted to a bearing-component receiver of the roof component, and the bearing component is held on the bearing-component receiver by a form-closure means.

### CROSS-REFERENCE TO RELATED APPLICATION(S)

This application claims the benefit of German Application No. 10 2023 135 240.7 filed Dec. 14, 2023, which is incorporated herein by reference in its entirety.

### TECHNICAL FIELD

A vehicle roof having an exposable roof opening and comprising a wind deflector device, assigned to the roof opening, which comprises a wind deflector bracket having lateral bearing arms and a respective deployment means that includes one of the two bearing arms, the deployment means being pivotably carried on a pivot bearing means located on the roof and carrying the wind deflector bracket for pivoting between a pivoted-down non-operated position and a pivoted-out operated position. The invention also relates to a method for mounting such a wind deflector device on a vehicle roof.

### BACKGROUND

A vehicle roof of the generic type, comprising a wind deflector device, has been disclosed by DE 10 2012 111 915 B3. The wind deflector device comprises a wind deflector bracket comprising a central wind deflecting profile and comprising lateral bearing arms that are pivotably carried on a respective pivot bearing located on the roof and that carry the wind deflector bracket for pivoting between a pivoted-down non-operated position and a pivoted-out operating position. A deployment lever is both hinge-mounted on the bearing arm and carried on a pivot bearing that is solid with the vehicle and that in particular is attached to a guide rail. The bearing arm and the deployment lever have to be mounted independently of each other, as parts of a deployment means, by means of respective pivot bearings on the roof, or on the guide rail, in particular by screw connections. Mounting of the deployment means of the wind deflector device on a roof component such as a guide rail is therefore complex.

### SUMMARY

The invention is based on the object of providing a vehicle roof mentioned at the outset, comprising a wind deflector device that is improved with regard to carrying the wind deflector device with ease of mounting, and to specify a method for simplified mounting of the wind deflector device of the above-mentioned vehicle roof.

The object is achieved according to the invention, in the case of the vehicle roof mentioned at the outset, in that the pivot bearing means has a bearing component on which the deployment means is carried, the bearing component is arranged on a roof component and is fitted to a bearing-component receiver of the roof component, and the bearing component is held on the bearing-component receiver by a form-closure means.

The object is further achieved by a method having the features of claim 16.

Advantageous configurations of the vehicle roof according to the invention are given in the dependent claims.

In the case of the vehicle roof according to the invention, the carrying of the deployment means of the wind deflector bracket is thus effected on this one bearing component, on which the constituent parts of the deployment means are carried or to which they are attached, and which is designed so that it is attached to the roof component in only one mounting procedure. The bearing component in this case is fitted or inserted on the bearing-component receiver of the roof component and held thereon by a form-closure means. The form-closure means is designed in such a way that an easily performed mounting movement is sufficient for fastening of the bearing component to the roof component, or to the bearing-component receiver, which can be performed manually or by use of a simple mounting means. Since the fastening of the bearing component is effected in particular without a screw connection or the like, the mounting of the bearing component is made particularly easy. Demounting is can also be performed easily.

The bearing component and the bearing-component receiver are configured and matched to each other in such a way that, when the bearing component is being mounted on the bearing-component receiver, the bearing component, after a first sequence of movements, which in particular comprises a pivot movement and/or a sliding movement of the bearing component relative to the bearing-component receiver, is brought into a position on the bearing-component receiver in which a form-closure engagement of the form-closure means is prepared. The form-closure means can then be activated by a longitudinal movement of the bearing component relative to the bearing-component receiver. The activated form-closure means holds the bearing component on the bearing-component receiver in its installed position or functional position on the roof component.

The form-closure engagement of the form-closure means can therefore be effected by a simple sliding movement of the bearing component relative to the bearing-component receiver. The fastening of the bearing component to the bearing-component receiver by the form-closure means can be easily released again by reversing the mounting movement. In particular, demounting is effected without use of screws or the like.

The bearing-component receiver is a part or portion of the roof component, e.g. a guide rail of the bearing of the cover or a part of such a guide rail. The bearing-component receiver may comprise a plurality of parts or portions of the roof component on which the bearing component is carried and is held in its installed position by the form-closure means, e.g. a base wall of a lateral frame part of the roof system frame.

The deployment means includes the respective bearing arm and, expediently, further components such as, for example, a deployment arm and/or a spring unit that comprises, for example, a tension spring or a helical tension spring. The deployment means includes, in particular, all the essential components necessary for deploying the wind deflector bracket.

Such a deployment means with the assigned pivot bearing means is provided on each of the two lateral bearing arms of the wind deflector bracket. The two bearing arms of the wind deflector bracket and the two deployment means are expediently arranged on both sides of the longitudinal centre plane of the vehicle roof and symmetrically with respect to it. The wind deflector device may be formed as a mesh wind deflector and have a mesh that is fastened both to the wind deflector bracket and to the roof, or to the roof frame or to the transverse part of the frame and, when the wind deflector bracket is deployed, assumes a tensioned, flat position for the purpose of influencing an air flow.

An actuating element for adjusting the wind deflector bracket may be, for example, a part of the cover, a part attached to or connected to the cover or a coupled part such as, for example, an adjusting mechanism of the cover. The position and movement of the actuating element or of the cover determine the pivot position of the wind deflector bracket. Preferably, there is respectively one actuating element in engagement on, for example, each bearing arm of the wind deflector bracket, e.g. in sliding engagement on the upper side of the bearing arm.

The axis and direction designations used in the description, such as, for example, “front” and “rear”, “top” and “bottom”, “outside” and “inside”, “horizontal” and “vertical”, as well as “lateral”, “transverse” and “longitudinal”, or in the transverse direction or y-direction and in the longitudinal direction or x-direction, relate to a three-dimensional x-y-z vehicle coordinate system, with the x-direction describing a longitudinal direction of the vehicle, the y-direction a transverse direction of the vehicle, and the z-direction a vertical direction of the vehicle. This coordinate system applies to the bearing component, with the longitudinal orientation of the bearing component corresponding to the x-direction for the description of the arrangement of the bearing component.

According to a preferred embodiment, it is provided that the form-closure means has at least two form-closure units, each form-closure unit comprising a form-closure element on the bearing component and a form-closure receiver, assigned to this form-closure element, on the bearing-component receiver. Each form-closure unit is designed in such a way that it holds the bearing component fixed in its installed position on the bearing-component receiver in the transverse direction and/or in the vertical direction. Expediently, when the bearing component is in the installed position, at least one of the form-closure units is arranged in such a form-closure position in which it supports or fixes the bearing component in the longitudinal direction and in particular rearward in the longitudinal direction.

Such a form-closure element comprises, for example, a cylindrical pin that has an enlarged pin head. Such a form-closure receiver expediently has a longitudinal guide, in particular a horizontal longitudinal guide, that is designed, for example, as an elongate guide recess formed in the bearing-component receiver. The longitudinal guide or guide recess has a width in the vertical direction or height that is matched to the diameter of the pin received therein in such a way that the pin is longitudinally displaceable in the longitudinal guide and is received substantially without play in the vertical direction. The pin head is of a greater diameter than the guide recess, such that it is supported on the longitudinal guide in the transverse direction. The length of the pin is selected in such a way that the bearing component is held on the bearing-component receiver substantially without play in the transverse direction. Each longitudinal guide includes an insertion opening, through which the respective pin may be inserted into the longitudinal guide by means of a movement of the bearing component in an x-z plane.

It is therefore expedient for at least one of the form-closure elements to be designed in such a way that, when in engagement on the assigned form-closure receiver, it holds the bearing component positioned on the bearing-component receiver in the transverse direction or y-direction. Forces acting upon on the bearing component in the transverse direction are supported on the bearing-component receiver via this at least one form-closure unit.

According to a preferred embodiment, it is provided that the bearing component is arranged, in the longitudinal orientation or x-direction, on the bearing-component receiver of the roof component extending laterally along the roof opening, and that the at least two form-closure elements and the respectively assigned form-closure receivers are mutually spaced in the longitudinal orientation of the bearing component and in the longitudinal orientation of the bearing-component receiver. A greater distance between the two form-closure elements, or the assigned form-closure receivers, provides secure support for the bearing component and force support on the bearing-component receiver with reduced bending moments.

According to a further preferred embodiment, it is provided that the first form-closure element is arranged in the region of the rear end of the bearing component and that the first form-closure receiver assigned to this first form-closure element has a first longitudinal guide on the bearing-component receiver, in which the first form-closure element inserted therein is formed for a longitudinal displacement of the bearing component along the longitudinal guide, as well as for a vertical pivoting of the bearing component. It is further provided that the second form-closure element is arranged on the bearing component in front of the first form-closure element in the longitudinal direction and that the second form-closure receiver assigned to this second form-closure element has a second longitudinal guide on the bearing-component receiver, in which the second form-closure element inserted therein is received so as to be displaceable longitudinally. This design allows a mounting of the bearing component in which the bearing component is first pre-positioned at its rear end on the bearing-component receiver by means of the first form-closure unit. The bearing component is then displaced in a mounting movement and thereby pivoted such that the bearing component is also pre-positioned with the second form-closure unit on the bearing-component receiver. A subsequent longitudinal movement of the bearing component, during which the two form-closure elements move longitudinally in the assigned form-closure receivers, guides the bearing component into its final installed position.

According to a preferred embodiment, it is provided that the first form-closure receiver includes an insertion opening that is arranged at the rear end of the first longitudinal guide and through which the first form-closure element can be inserted into the first longitudinal guide. The second form-closure receiver includes an insertion opening that is arranged at the front end of the second longitudinal guide and that is formed in such a way that the second form-closure element can be inserted in a vertical lowering movement as the bearing component pivots about the first form-closure element, which is received in the first longitudinal guide. Expediently, when pivoting, the bearing component is in such a position in which the first form-closure element bears against the front end of the first longitudinal guide and thus defines a pivot axis for the pivoting of the bearing component.

According to a preferred embodiment, it is provided that the form-closure means has a third form-closure unit in addition to the second form-closure unit. The third form-closure unit is of the same design as the second form-closure unit. The second form-closure unit is expediently assigned to the region of the front end of the bearing component. The third form-closure unit is assigned to a middle region of the bearing component with respect to the longitudinal extent of the bearing component. The third form-closure unit provides additional fastening and supporting of the bearing component on the bearing-component receiver.

Expediently, the bearing-component receiver includes a web, which extends in an upright position or orientation along the roof component and on which the form-closure receivers are formed. In particular, the web is part of the guide rail, which includes at least one guideway for the bearing means of the cover. The guideway is arranged, for example, on the laterally outward-facing outer side of the web. As part of the roof component or of the guide rail, which is formed in particular as a metal or aluminum profile, the web is a component with sufficient strength to securely carry the bearing component and also to securely support the forces acting upon the bearing component via the wind deflector device.

According to a preferred embodiment, it is provided that the form-closure means has a latching element, arranged on the bearing component, which is in latching engagement in a latching recess of the bearing-component receiver, or of the web, and holds the bearing component positioned in the longitudinal orientation or x-direction on the bearing-component receiver, or on the web. The latching element thus secures the bearing component in its installed position against unwanted longitudinal displacement. The latching element expediently includes two mutually opposite latching engagement faces, which prevent longitudinal displacement of the bearing component when in engagement on assigned edges of the bearing-component receiver, or of the web, that delimit the latching recess.

According to a further preferred embodiment, it is provided that the latching element is arranged in an elastically deformable deformation region of the bearing component and can be released from its latching engagement by elastic deformation of this deformation region in the transverse direction or y-direction. This design facilitates releasing of the latching engagement of the latching element during removal or demounting of the bearing component from the bearing-component receiver. This design also facilitates the displacement of the latching element into its latching engagement when the bearing component is being mounted on the bearing-component receiver, during which the bearing component executes a lowering movement. In the process, the latching element, expediently comprising a beveled end face directed outward, contacts an upper edge of the bearing-component receiver, or of the web, next to the latching recess, and is displaced by this inward and behind the web, while the deformation region is deformed by lateral bulging. During the subsequent longitudinal displacement of the bearing component into its final installed position, the latching element is pressed into the latching recess by the deformation region, which deforms back again.

Expediently, the bearing component includes, on its deformation region, an actuating contour for engagement of an actuating tool that causes the deformation. The bearing component preferably bears with its deformation region directly and without any gap on the bearing-component receiver, or on the web. Such an actuating contour facilitates the bulging of the deformation region by use of the actuating tool when the latching element is to be released from the latching recess, e.g. when the bearing component is being removed. The actuating contour is formed, for example, as a shallow depression that is arranged on the side of the bearing component facing toward the web and is designed for insertion of an actuating tool having, for example, a wedge-shaped tip such as, for example, a screwdriver, from above.

According to a further preferred embodiment, it is provided that the form-closure means has a further form-closure unit having a hook-shaped form-closure element, which is arranged on an underside of the bearing component, in the locking position engages behind an assigned form-closure receiver on a frame base of the bearing-component receiver and holds the bearing component fixed on the bearing-component receiver in the vertical direction or z-direction. The form-closure element is, for example, a locking hook, which is arranged on the underside of the bearing component in the front region of the bearing component and is directed rearward in the longitudinal direction of the bearing component. The form-closure receiver assigned to the latch hook includes a locking opening, which is formed in the base of the roof component or in the frame base and assigned the locking hook. When the bearing component is in the installed position, the locking hook arranged in the locking opening engages behind the frame base delimiting the locking opening in its locking position into which it has been brought by the longitudinal displacement of the bearing component during mounting. The locking hook of this form-closure unit thus secures the bearing component on the frame base of the bearing-component receiver and prevents it from being lifted in the z-direction or vertically. This supporting is effected in the transverse direction, at a distance from the supporting of the front form-closure unit on the web and in addition to this supporting, such that an overall improved supporting is provided in the z-direction, in which the supporting forces are divided between these two supporting elements.

The bearing component expediently includes at least one bearing for the bearing arm, a bearing for a deployment lever and a fixing means for a deployment spring. The deployment spring is expediently provided as a helical tension spring and extends in the longitudinal direction of the bearing component. The size and, in particular, the length of the deployment spring is a design factor in the designing of the bearing component and in definition of its length.

According to a further preferred embodiment, it is provided that the elongate bearing component has a vertical side wall and a horizontal base wall, and that the bearings for the deployment means are formed and/or supported predominantly or entirely on the base wall.

When the bearing component is in the installed position, the vertical side wall bears on the web of the bearing-component receiver. The base wall is secured on the roof component or the guide rail. The elongate bearing component is in principle formed with the base wall and with the side wall, in cross-portion, as a corner profile or angle profile. The deployment spring is arranged on the bearing component above the base wall and laterally exposed next to the side wall. The deployment spring can thus be easily attached to the bearing component, as well as to the bearing arm.

It is furthermore preferred that the form-closure elements of the form-closure units assigned to the web of the bearing-component receiver are arranged on the side wall of the bearing component, and the form-closure element of the form-closure unit assigned to a frame base of the bearing-component receiver is arranged on the base wall of the bearing component.

According to a further preferred embodiment, it is provided that the bearing component has a component reinforcement or support structure, which includes a plurality of ribs and supports a fastening portion that includes the fixing means for the deployment spring. Such a component reinforcement or support structure serves to support the spring force and the forces applied to the bearing component via the wind deflector bracket. The bearing component may therefore in principle be designed with thinner walls and in an open shape such as the corner or angle profile, for which less material is required. The fastening portion is expediently supported on the side wall and may additionally be supported forward in the longitudinal direction via a support elevation, which is connected to the base wall and preferably also to the side wall and is supported thereon. Depending on the support required, the ribs are preferably longitudinal ribs and/or transverse ribs. The ribs are arranged, for example, on the upper side of the fastening portion. The fastening portion is preferably formed as a downwardly open structure and is designed, in particular, for molding by means of an injection mould that produces the entire bearing component. Expediently, the downwardly open structure of the fastening portion is reinforced on its underside or inner side by ribs. The support elevation may also be formed as a downwardly open structure and be reinforced by ribs or by a ribbed structure.

Accordingly, a preferred design provides that the bearing component has the base wall in a front region that faces toward the wind deflector bracket and in a middle region, and that its rear region is formed as a downwardly open support structure for the fastening portion of the deployment spring that includes the fixing means. The front region and the middle region include the bearings for the bearing arm and for the deployment lever.

A method according to the invention for mounting a wind deflector device on a vehicle roof according to any one of claims 1 to 15, or as set out above, is characterized by the steps:
a) attaching and supporting the deployment means on the bearing component, the deployment spring,
during this first mounting step or
following the mounting of the bearing component into its installed position, being clamped between the bearing component and the bearing arm,
b) mounting the bearing component on the bearing-component receiver, in that the bearing component in a first mounting position contacts the bearing-component receiver by means of the first form-closure unit,
c) performing a mounting movement that includes a pivot movement of the bearing component and by which the bearing component contacts the bearing-component receiver by means of at least one further form-closure unit, and
d) performing a mounting movement by which the bearing component is guided, in a longitudinal movement guided relative to the bearing-component receiver, into its installed position and the form-closure units thereby activate their respective form-closure engagement.

Expediently provided between steps b) and c) is a step having the following features:
performing a mounting movement by which the bearing component is positioned, in a longitudinal movement guided relative to the bearing-component receiver, in such a mounting position in which at least one further form-closure unit is prepared for a form-closure engagement on the bearing-component receiver.

This longitudinal movement of the bearing component is performed, in particular, in the opposite direction to the longitudinal movement of the bearing component in step d).

### BRIEF DESCRIPTION OF DRAWINGS

In the following, the invention is explained in more detail on the basis of an exemplary embodiment of a vehicle roof according to the invention and with reference to the drawing, in which:

FIG. 1 shows an isometric view of an openable vehicle roof with a cover of a roof system arranged in the closed position and covering a roof opening;

FIG. 2 shows an isometric view of the vehicle roof of FIG. 1, with the cover displaced to the rear and a wind deflector device pivoted out into its functional position when the roof is open;

FIG. 3 shows an isometric view of a portion of a roof system frame at its left front corner region, with the wind deflector device arranged in a lowered non-operated position, and with a pivot bearing means of a deployment means of the wind deflector device;

FIG. 4 shows a side view of the wind deflector device arranged in the non-operated position with a bearing component of the pivot bearing means;

FIG. 5 shows a side view, as shown in FIG. 4, of the wind deflector device with the bearing component arranged in the pivoted-out functional position;

FIG. 6 shows an isometric side view of the bearing component;

FIG. 7 shows a side view of the bearing component in its installed position, secured by a form-closure means, on a roof component;

FIG. 8 shows in a cross-sectional view, according to sectional plane A-A in FIG. 7, the bearing component in its installed position on the roof component;

FIG. 9 shows in a sectional view, according to sectional plane B-B in FIG. 7, the bearing component in its arrangement on the roof component;

FIG. 10 shows in a side view according to FIG. 4, in an enlarged representation, a portion of the bearing component with a latching element arranged at a deformation region of the bearing component;

FIG. 11 shows a bottom view of the roof component with an opening for a form-closure element of the bearing component engaging therein;

FIG. 12 shows an isometric view of the bearing component with bearings for the deployment means and with a reinforcing structure of the bearing component;

FIG. 13 shows an isometric view of the underside of the bearing component with laterally projecting form-closure elements and with a reinforcing support structure;

FIG. 14 shows a bottom view of the bearing component;

FIG. 15 shows an isometric view of the bearing component in a first mounting position during its mounting on the roof component;

FIG. 16 shows an isometric view of the bearing component in a second mounting position;

FIG. 17 shows an isometric view of the bearing component in a third mounting position;

FIG. 18 shows an isometric view of the bearing component in a fourth mounting position; and

FIG. 19 shows an isometric view of the bearing component in its mounted installed position.

### DETAILED DESCRIPTION

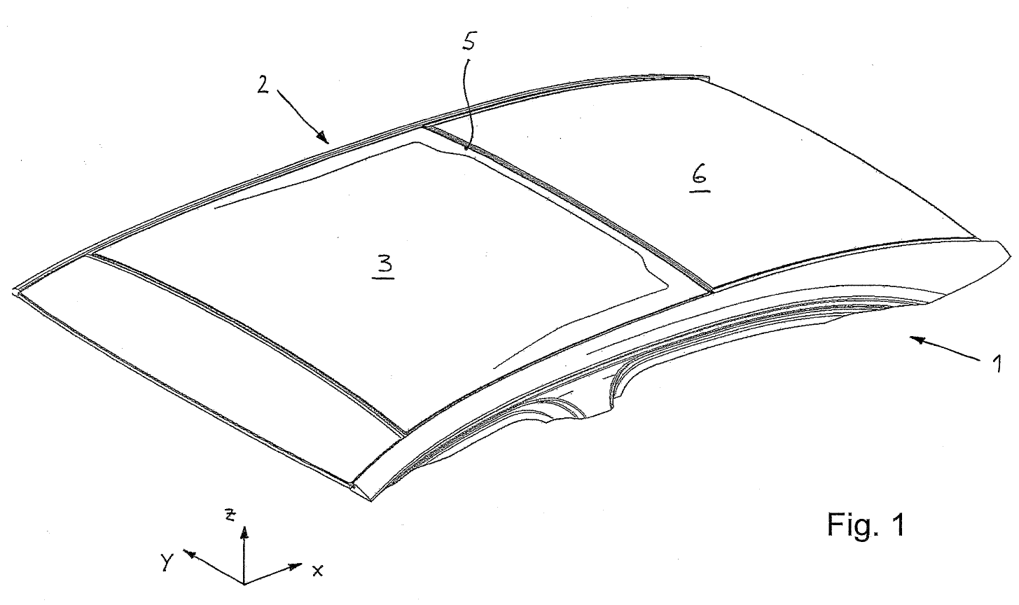

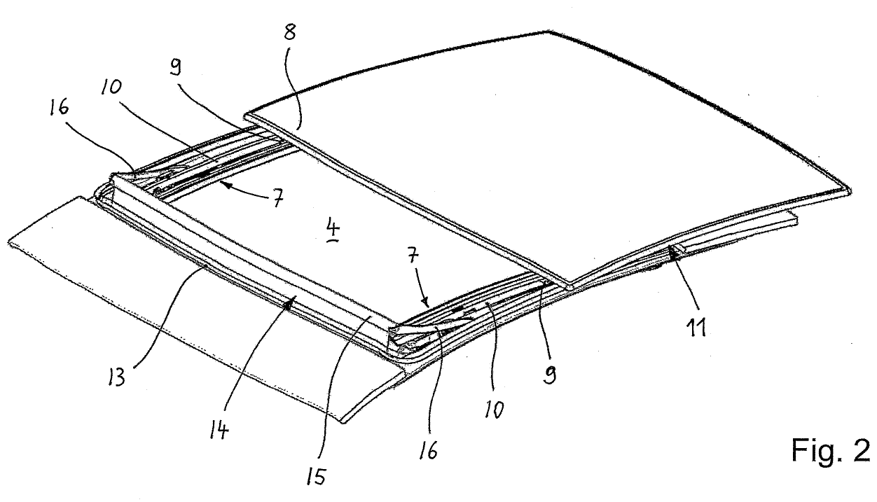

An openable vehicle roof 2 of a vehicle 1 such as, for example, a passenger car has a roof system comprising a cover 3 that can be raised with its rear edge 5 from a closed position (FIG. 1) in a roof opening 4 and adjusted into a ventilation position, and can be moved with its rear edge 5 from the raised ventilation position into an open position (FIG. 2) over a roof surface 6 adjoining behind the roof opening 4 in the longitudinal direction of the vehicle or roof. Such a roof system is, for example, an externally guided sliding roof or a spoiler roof. The rear roof surface 6 may in principle be formed by a roof fixed to the vehicle or by a movable roof part.

The roof system has a roof system frame 7, which is substantially rectangular and on which the cover 3 is movably mounted. Expediently, also arranged on the roof system frame 7 is a drive means for adjusting the cover 3. The roof system frame 7 is fastened to the vehicle roof or to a vehicle roof frame in such a way that it surrounds the roof opening 4.

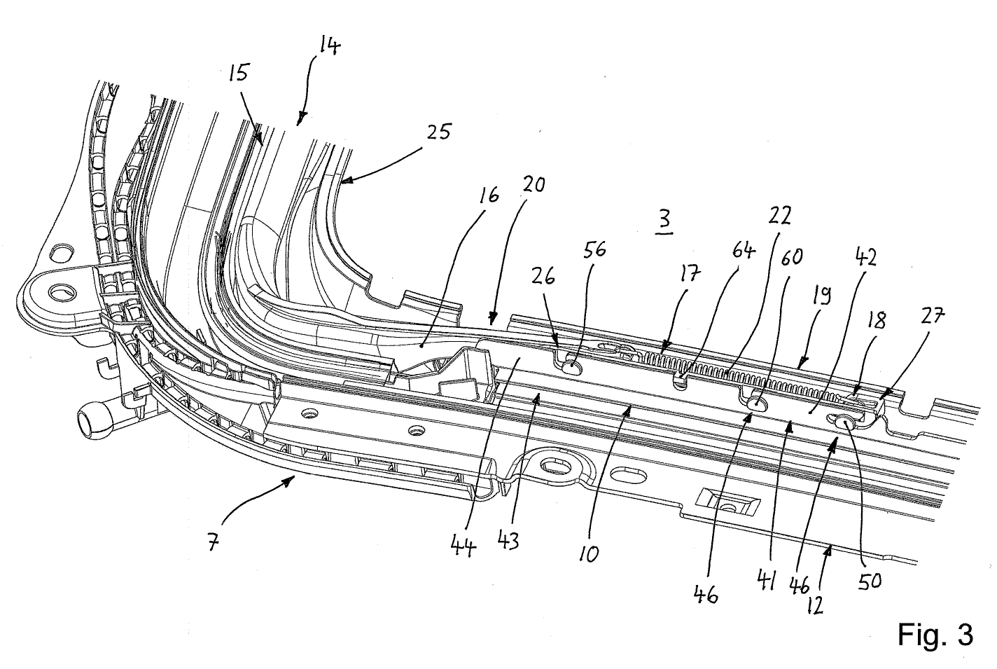

A bearing device that carries the cover 3 is designed in such a way that the cover 3 is carried on both sides of the roof opening 4, by means of a respective front cover bearing unit 9 of the bearing device arranged under its front region 8, in a displaceable manner along a lateral guide rail 10 arranged on the roof, so as to be pivotable with respect to the guide rail, and can be pivoted out into its ventilation position by means of a rear cover bearing unit 11, which is expediently also carried on the guide rail 10 and has, for example, a rear deployment lever. The guide rail 10 is preferably integrally formed on a lateral frame part 12 (FIG. 3) of the roof system frame 7. The lateral frame part 12 is, for example, a light-metal extrusion profile. Such a bearing device of the cover 3 is known, for example, from DE 10 2014 014 171 B4.

The roof structure is largely symmetrical with respect to a vertical longitudinal centre plane of the vehicle roof 2, such that the following description is given on the basis of the components arranged on one or the left longitudinal side of the roof opening 4, or on the left lateral frame part 12.

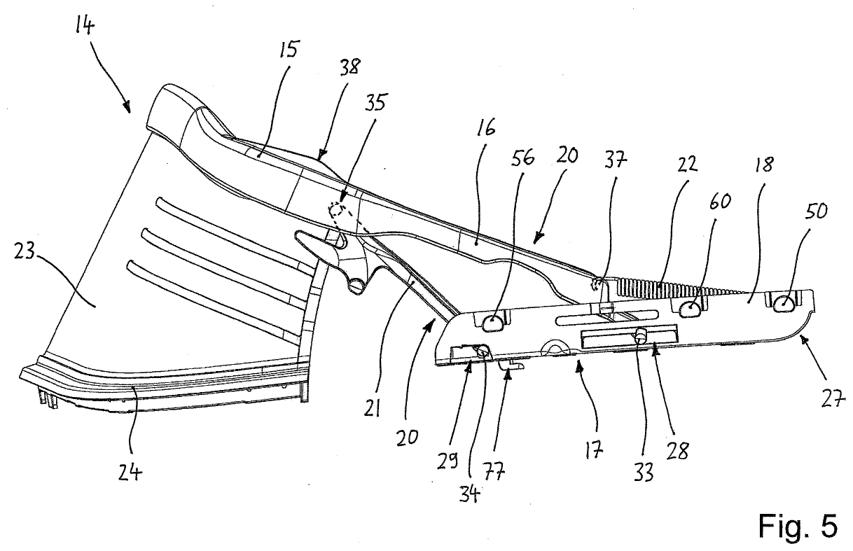

A wind deflector device 14 (see FIGS. 2 and 5) assigned to a front edge 13 of the roof opening 4 includes a wind deflector bracket 15 with a respective lateral bearing arm 16 extending to the rear in the longitudinal direction or x-direction on both sides. A pivot bearing means 17 (FIG. 5) of the wind deflector device 14 includes a bearing component 18 (see, for example, FIGS. 3 to 6 and 12), which is attached to a roof component 19. The roof component 19 is preferably formed by a front portion of the lateral frame part 12. In principle, the wind deflector device 14 may also be arranged on a portion of the fixed vehicle roof, such that the roof component 19 is a roof-fixed part or is attached to a roof-fixed part.

The bearing component 18 carries a deployment means 20 (FIG. 5) of the wind deflector device 14. The deployment means 20 comprises at least the bearing arm 16 of the wind deflector bracket 15, and expediently also further components such as a deployment lever 21 and a deployment force means, in particular a deployment spring 22 in the form of a helical spring or tension spring. The deployment means 20 comprises, in particular, all parts that are provided for carrying the wind deflector bracket 15 in a movable manner.

The wind deflector device 14 has a wind deflector mesh 23 (see FIG. 5), which is fastened at its upper edge to the wind deflector bracket 15 and at its lower edge, by means of a mesh base strip 24 or the like, to the roof or to the roof system frame 7, in particular to a front transverse frame part 25 (FIG. 3) of the roof system frame 7, and assumes a tensioned flat position for influencing an air flow when the wind deflector bracket 15 is deployed. The lateral frame part 12 and the front transverse frame part 25 are connected to each other, for example by screw connection and/or adhesive bond, but in an alternative design may also be formed as a single piece.

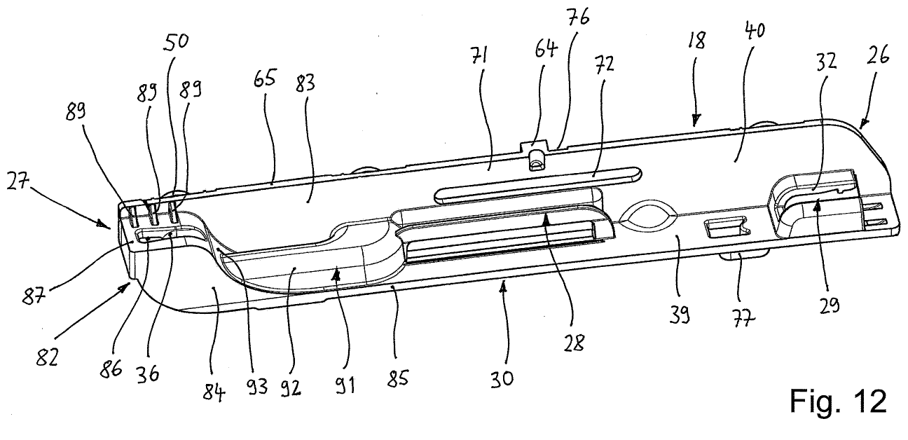

In its installed position (FIG. 3), the bearing component 18 is arranged in longitudinal orientation on the roof component 19 and parallel to the guide rail 10 of the roof component 19, or of the lateral frame component 12. Its front end 26 in this case is directed forward in the direction of the wind deflector bracket 15, and its rear end 27 is directed rearward in the opposite direction. The bearing component 18 includes a first bearing 28 (FIG. 12) for carrying the bearing arm 16, and a second bearing 29 for carrying the deployment lever 21. With regard to the longitudinal extent of the bearing component 18, the first bearing 28 is arranged in a middle region 30 of the bearing component 18, and the second bearing 29 is arranged in the region of the front end 26 of the bearing component 18. The two bearings 28 and 29 have longitudinally extending bearing guides 31 and 32, on which the bearing arm 16 is carried at its rear end 33 and the deployment lever 21 is carried at its rear end 34 by means of respective sliding elements or sliding pins or the like so as to be pivotable about a transverse axis and longitudinally displaceable in a sliding manner. The deployment lever 21 is carried at its front end 35 on the bearing arm 16 so as to be pivotable about a transverse pivot axis.

The deployment spring 22 is fastened or suspended both to a fixing means 36 (FIG. 12), which is formed in particular as a spring suspension, in the region of the rear end 27 of the bearing component 18, and to a fixing means 37 or suspension arranged on the bearing arm 16 at such a site above the bearing of its rear end 33, or of the first bearing 28, that it applies its tensile force to the bearing arm 16 in the pivoting-out direction of the wind deflector bracket 15.

The bearing arm 16 has a slideway 38 on its upper side. The cover 4 has an engagement part (not represented) assigned to the slideway 38, which is in the form, for example, of a control slider and is expediently formed by means of a polyurethane foaming of the cover 4 on the underside of the cover 4 adjacent to the front edge of the cover. When the wind deflector device is in the pivoted-out functional position (FIG. 5), the cover 4 is in a position in which the roof opening 4 is at least partially open and in which the cover 4 is removed from the wind deflector device 14, or from the bearing arm 16. The deployment spring 22, via its engagement on the bearing arm 16, holds the wind deflector bracket 15 in a pivoted-out position, in which the wind deflector mesh 23 is tensioned and the likewise pivoted-up deployment lever 21 is arranged, at its rear end 34, in its bearing 29 on the bearing component 16, in a rear stop position. The positions, described above, of the wind deflector bracket 15 with the components of the deployment means 20 are implemented in the opposite sequence of movements when the cover 4 is opened from its closed position to an open position.

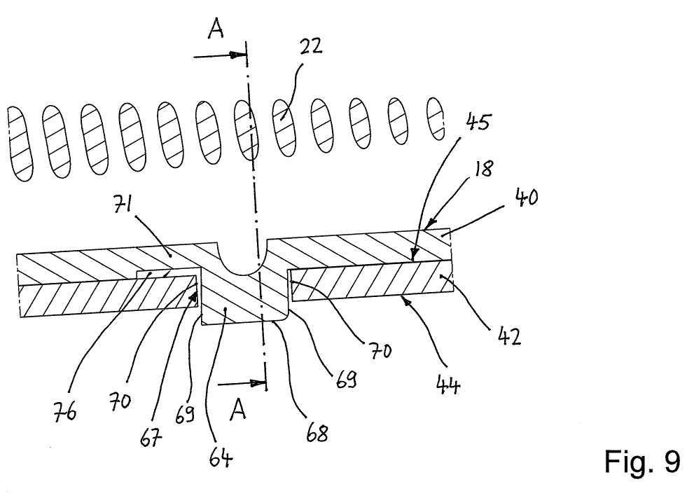

The elongate bearing component 18 is in principle formed in cross-portion as a corner profile having a base wall 39 and a side wall 40 (FIG. 12) and is produced, in particular, as an injection-molded part, e.g. from metal and preferably from plastic. In its installed position (FIG. 3), the bearing component 18 is arranged on a bearing-component receiver 41 of the roof component 19. The bearing-component receiver 41 includes a web 42, which is arranged vertically on the roof component 19 and extends along the roof component 19. The web 42 is, for example, a part of the guide rail 10, which includes at least one guideway 43 for the bearing device of the cover 4. The guideway 43 is arranged on the laterally outwardly directed outer side 44 of the web 42. The bearing component 18 is arranged on the opposite inner side 45 of the web 42 in such a way that it faces with its side wall 40 toward the web 42 and, in particular, bears directly against the web 42 (FIGS. 3 and 9), with its front end 26 directed forward in the direction of the wind deflector bracket 15 and its rear end 27 directed rearward in the opposite direction.

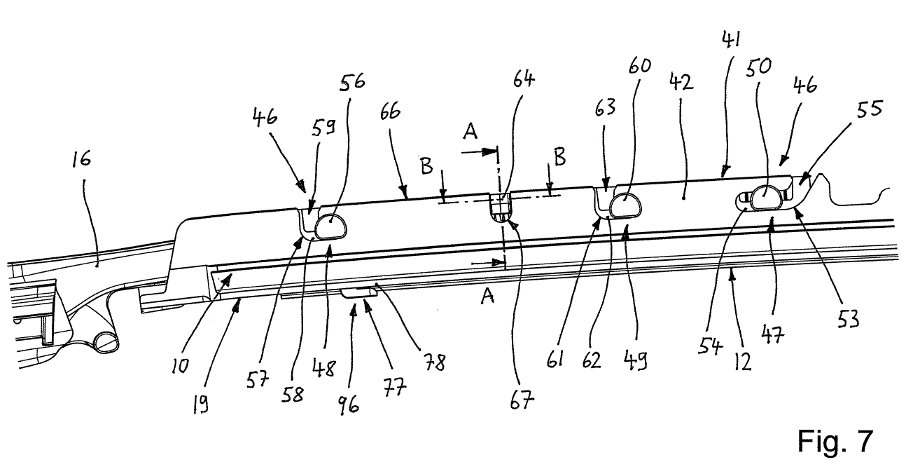

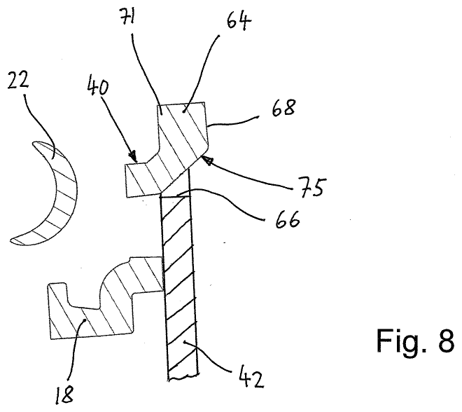

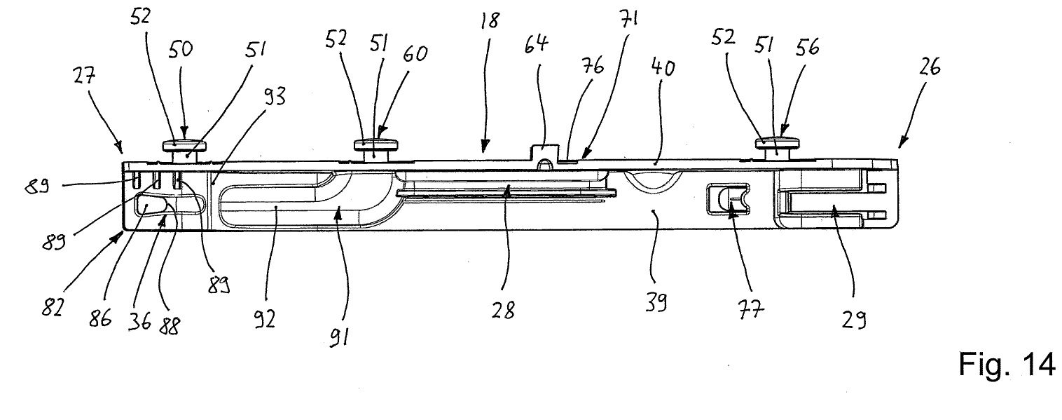

The bearing component 18 is held on the web 42 of the bearing-component receiver 41 by a form-closure means 46 (FIGS. 7 and 14). The form-closure means 46 includes three form-closure units 47, 48 and 49. The first and, with respect to the bearing component 18, rear form-closure unit 47 has a form-closure element 50, which is in the form of a cylindrical pin 51 that has an enlarged pin head 52 and projects laterally outward from the side wall 40 near the rear end 27 of the bearing component 18. The form-closure unit 47 additionally also has a form-closure receiver 53, which is assigned to the form-closure element 50 and is formed on the web 42 of the bearing-component receiver 41 in the form of a longitudinal guide 54 parallel to the guide rail 10. The longitudinal guide 54 is expediently formed by an elongate guide recess in the web 42. The longitudinal guide 54 is designed in such a way and has an insertion opening 55 at its rear end, such that the form-closure element 50 can be inserted into the longitudinal guide 54 via the insertion opening 55 and can be guided in the longitudinal guide 54 in the vertical direction substantially without play, and can be displaced longitudinally. The pin head 52 of the form-closure element 50, the diameter of which is greater than the height of the longitudinal guide 54 in the vertical or Z direction, holds the form-closure element 50 secured to the web 42 in the transverse direction.

The second and, with respect to the bearing component 18, front form-closure unit 48 has a form-closure element 56 that is formed in the same way as the form-closure element 50 of the first form-closure unit 47 and projects laterally outward from the side wall 40 near the front end 26 of the bearing component 18. The front form-closure unit 48 additionally has a form-closure receiver 57, which is assigned to the form-closure element 56 and is formed on the web 42 of the bearing-component receiver 41 in the form of a longitudinal guide 58 parallel to the guide rail 10 and of the same design as the longitudinal guide 54. The longitudinal guide 58 has at its front end an insertion opening 59 that is upwardly open and via which the form-closure element 56 can be inserted into the longitudinal guide 58 from above.

The third, or middle, form-closure unit 49 is arranged between the first form-closure unit 47 and the second form-closure unit 48 and has a form-closure element 60 that is formed in the same way as the two form-closure elements 50 and 56 and projects laterally outward from the side wall 40 in the middle region 30 of the bearing component 18, for example at a distance of one third of the length of the bearing component 18 from the rear end 27 of the bearing component 18. The third, middle form-closure unit 49 additionally has a form-closure receiver 61, which is assigned to the form-closure element 60 and is formed on the web 42 of the bearing-component receiver 41 in the form of a longitudinal guide 62 parallel to the guide rail 10 and is of the same design as the longitudinal guide 58 of the second form-closure unit 48. The longitudinal guide 62 has at its front end an insertion opening 63 that is upwardly open and via which the form-closure element 60 can be inserted into the longitudinal guide 62 from above.

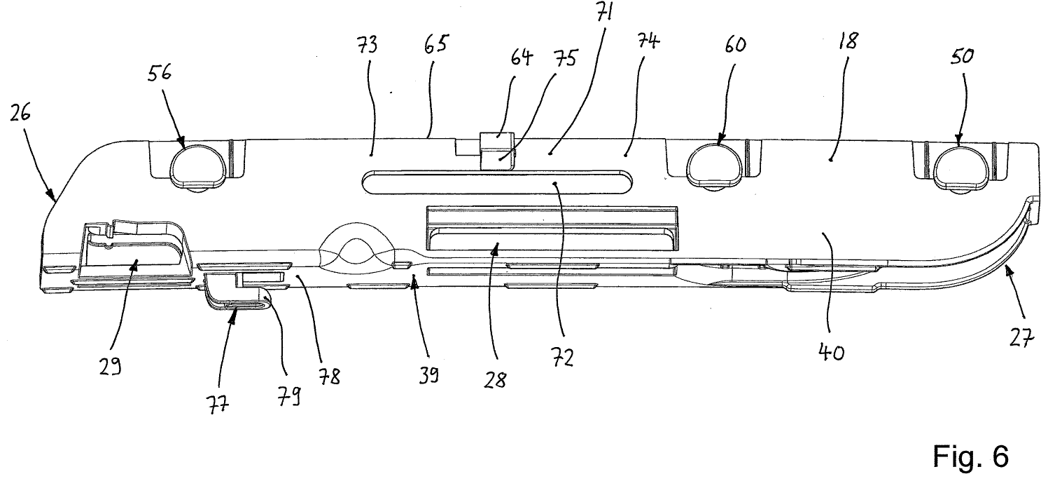

The form-closure means 46 further comprises a latching element 64 (FIGS. 6, 9 and 10), which projects laterally outward from the side wall 40 of the bearing component 18 in the transverse direction and is arranged in the region of the upper edge 65 of the side wall 40 and approximately between the middle form-closure element 60 and the front form-closure element 56. At its upper edge 66, the web 42 has a latching recess 67 (FIG. 7), which is assigned to the latching element 64 and in which the latching element 64 is received in the latching position when the bearing component 18 is arranged in the installed position. The latching element 64 is expediently formed in the shape of a cuboid block having an end face 68 and two lateral mutually opposite latching engagement faces 69, and projects from the side wall 40 in such a way that, in the latching position, it is arranged with its end face 68 at least level with the outer side 44 of the web 42 or, expediently, also protrudes beyond it (FIG. 9). The latching element 64 is received with its two latching engagement faces 69 in the latching recess 67, almost or entirely without play in the longitudinal direction or x-direction. The two latching engagement faces 69 block a longitudinal displacement of the bearing component 18 when in engagement at assigned edges 70 of the web 42 delimiting the latching recess 67.

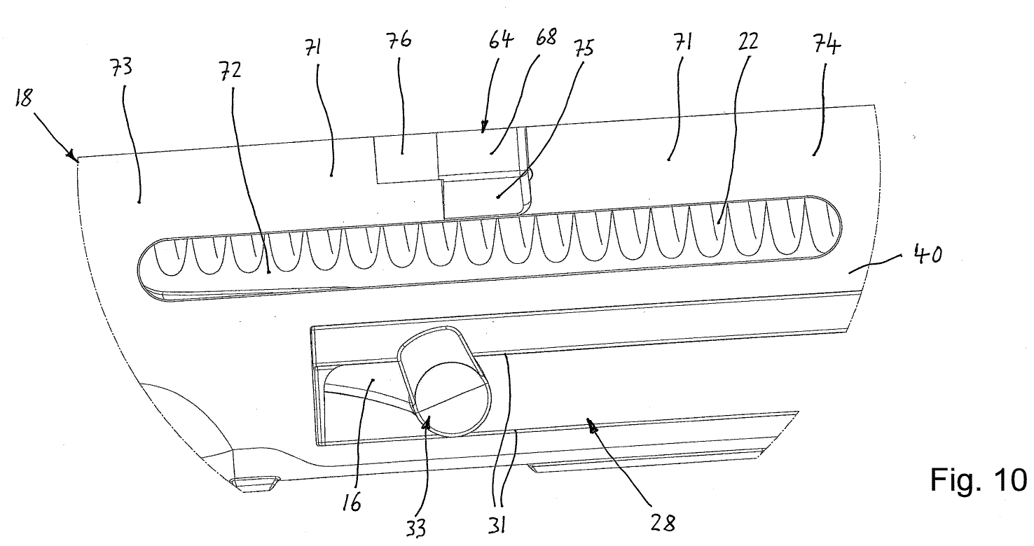

The side wall 40 of the bearing component 18 has an elastically deformable deformation region 71 (FIGS. 6 and 10), on which the latching element 64 is arranged. Beneath the deformation region 71, the side wall 40 has an elongate recess 72, such that the deformation region 71 is connected to the side wall 40 only via its front portion 73 and via its rear portion 74. This enables the deformation region 71 to be elastically deformable in the transverse direction, such that the latching element 64 is displaced out of the latching recess 67 in the transverse direction or y-direction by lateral bulging of the deformation region 71 carrying the latching element 64. The length, width and design of the deformation region 71 defined by the recess 72 is selected in dependence on the design and material of the bearing component 18 and with regard to the wanted elastic deformability of the deformation region 71.

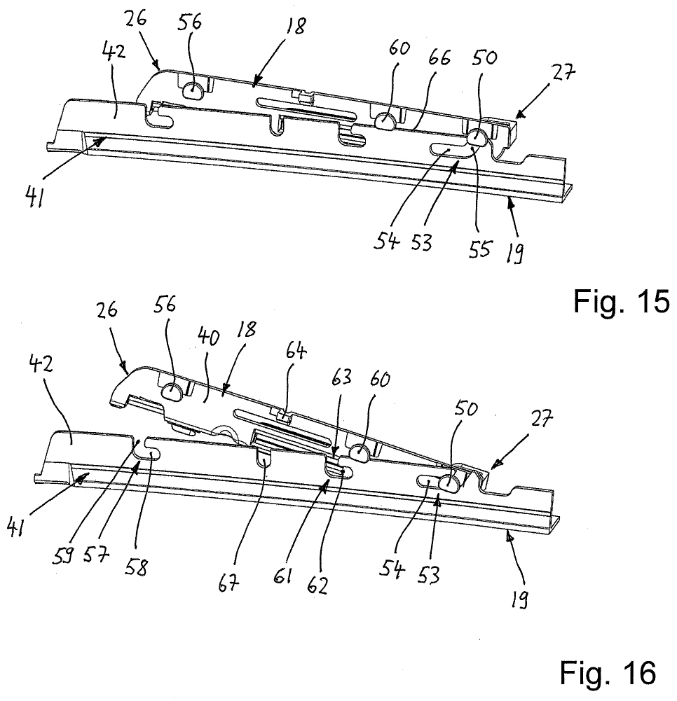

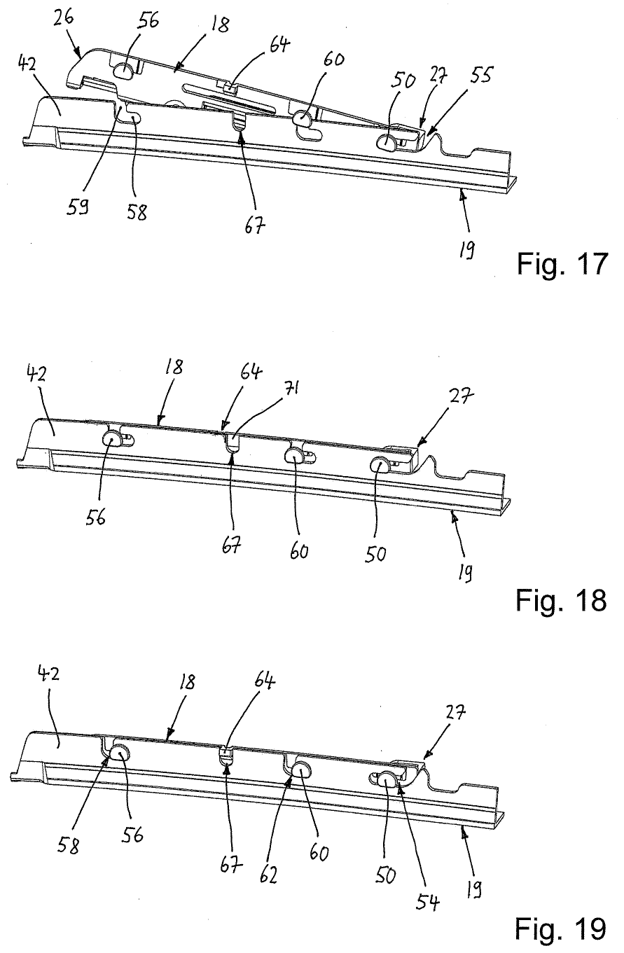

The mounting of the bearing component 18 on the bearing-component receiver 41 is effected in such a way that first (FIG. 15) the bearing component 18 is positioned with its rear end 27 in the region of the rear form-closure receiver 53 in such a way that the rear form-closure element 50 can be inserted into the insertion opening 55. The bearing component 18 is supported with its middle form-closure element 6 on the upper edge 66 of the web 42 and assumes an inclined position or assembly position with its front edge 26 pivoted upward, while it is pivoted into the mounting position represented in FIG. 16 as the form-closure element 50 is lowered into the longitudinal guide 54. In this position, the bearing component 18 is displaced forward, with the rear form-closure element 50 moving forward in the rear longitudinal guide 54 as far as its front end and the middle form-closure element 60 having reached the middle insertion opening 63 (FIG. 17). The bearing component 18 is then pivoted down into a position (FIG. 18) in which it is arranged parallel to the guide rail 10 and to the upper edge 66 of the web 42. During this movement, the middle form-closure element 60 and the front form-closure element 56 have lowered to their respective longitudinal guide 62 and 58.

Upon the bearing component 18 being pivoted down from the position of FIG. 17 into the position of FIG. 18, the latching element 64 contacts the upper edge 66 of the web 42 next to the latching recess 67. A sub-portion of the end face 68 of the latching element 64 is formed with a bevel 75 shaped in such a way that the upper edge 66 of the web 42 contacts this bevel 75 as the latching element 64 is lowered, and presses the latching element 64 with the bulging deformation region 71 laterally inward in the transverse direction and positions it on the inner side 45 of the web 42.

In the final step (movement from FIG. 18 to FIG. 19), the bearing component 18 is displaced rearward, being guided by the three form-closure elements 50, 56 and 60 in the assigned longitudinal guides 54, 58 and 62, which effect longitudinal guiding. The latching element 64, which is preloaded by the deformation region 71 against the inner side 45 of the web 42, slides toward the latching recess 67 and, when it reaches the latching recess 67, is pressed into the latching recess 67 by the deformation region 71, which deforms back into its initial position. The two form-closure elements 56 and 60 in this case may bear against the rear ends of the two longitudinal guides 58 and 62 or be spaced apart from them.

On its deformation region 71, the bearing component 18 has an actuating contour 76 (FIGS. 9 and 10) for engagement of an actuating tool that causes the deformation or bulging of the deformation region 71. The actuating contour 76 is formed, for example as a shallow depression in the deformation region 71 on its side that faces toward the web 42, which is formed for insertion of an actuating tool having, for example, a wedge-shaped tip, such as, for example, a screwdriver. The actuating tool, or the screwdriver, is used to push the deformation region 71, which deforms elastically in the transverse direction, laterally away from the web 42, such that the latching element 64 is likewise displaced laterally out of the latching recess 67 to such an extent that the bearing component 18 can be shifted forward. In this process, the latching element 64 slides on the inner side 45 of the web 42.

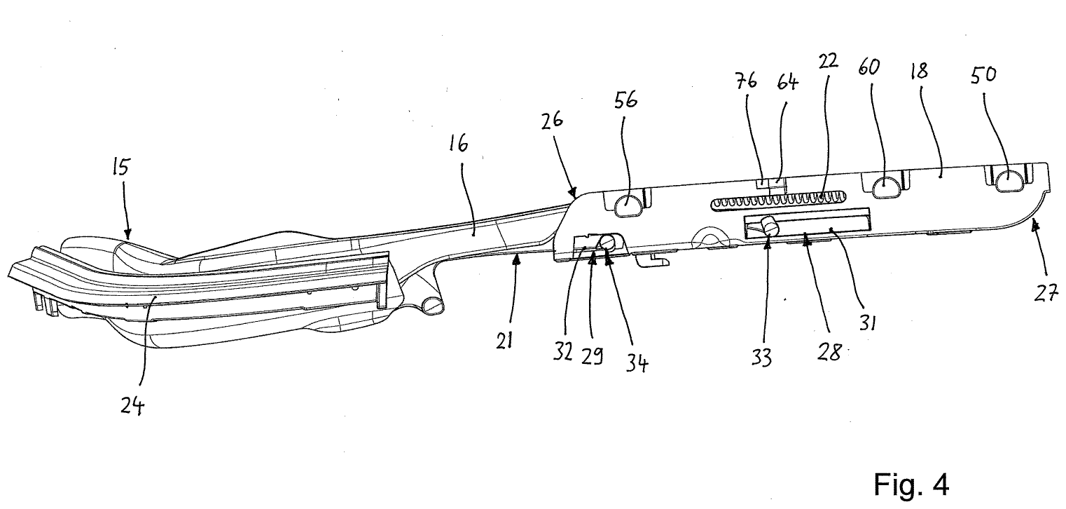

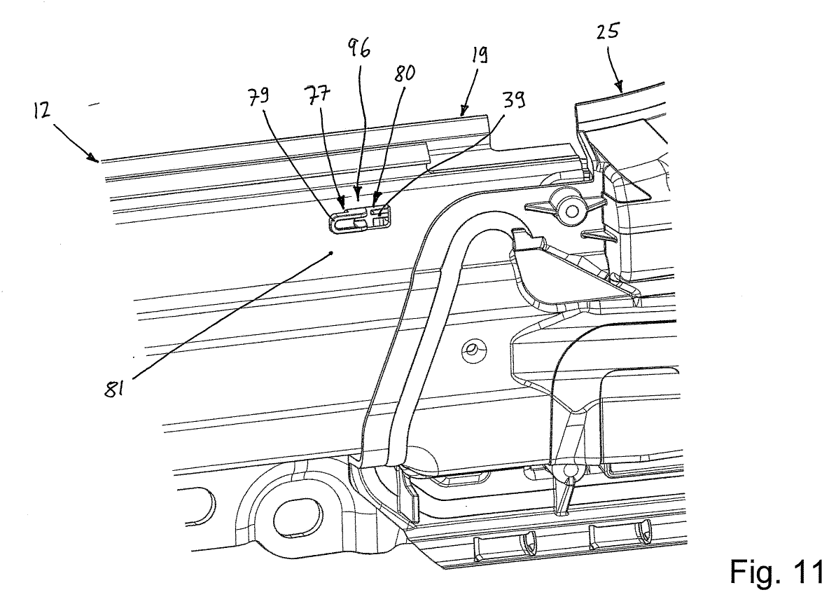

The form-closure means 46 includes a further form-closure unit 96 having an in particular hook-shaped form-closure element in the form of a fixed locking hook 77 (FIGS. 4 and 6), which is arranged or integrally formed on the underside 78 of the base wall 39 of the bearing component 18 in the longitudinal direction close behind the second bearing 29, protrudes downward and is directed rearward with its free hook end 79. The bearing-component receiver 41 includes a form-closure receiver, in the form of a locking opening 80 (FIG. 11), assigned to the form-closure element, or the locking hook 77. The locking opening 80 is formed on a frame base 81 of the frame part 12, or of the roof component 19, which forms a further part of the bearing-component receiver 41, in such a size and position that, during mounting of the bearing component 18 and upon it being pivoted down from the position of FIG. 17 into the position of FIG. 18, the locking hook 77 can be lowered through the locking opening 80. Upon the subsequent longitudinal displacement of the bearing component 18 from the position of FIG. 18 to the position of FIG. 19, the locking hook 77 engages behind the frame base 81 and forms a form-closure locking of the locking hook 77 on the frame base 81 in the z-direction, and thus secures the bearing component 18 against lifting in the vertical or z-direction.

The bearing component 18 is preferably formed as a plastic injection-molded part and has at least one component reinforcement or support structure that assists in supporting the force of the tension spring or deployment spring 22. The bearing component 18 includes a fastening portion 82 (FIG. 12) that comprises the fixing means 36 and on which the deployment spring 22 is suspended and thus fixed to the bearing component 18. The fastening portion 82 is integrally formed onto the inner side 83 of the side wall 40 in the region of the rear end 27 of the bearing component 18 and extends in the transverse direction approximately across the width of the base wall 39. A lateral outer wall 84 delimits the fastening portion 82 on the side opposite the side wall 40. The outer wall 84 is formed as a flat extension of an edge 85 of the base wall 39 of the bearing component 18. The bottom wall 39 ends in front of the fastening portion 82 to the longitudinal extent of the bearing component 18. The fastening portion 82 is formed as a downwardly open structure and is designed, in particular, for molding by means of an injection molding die.

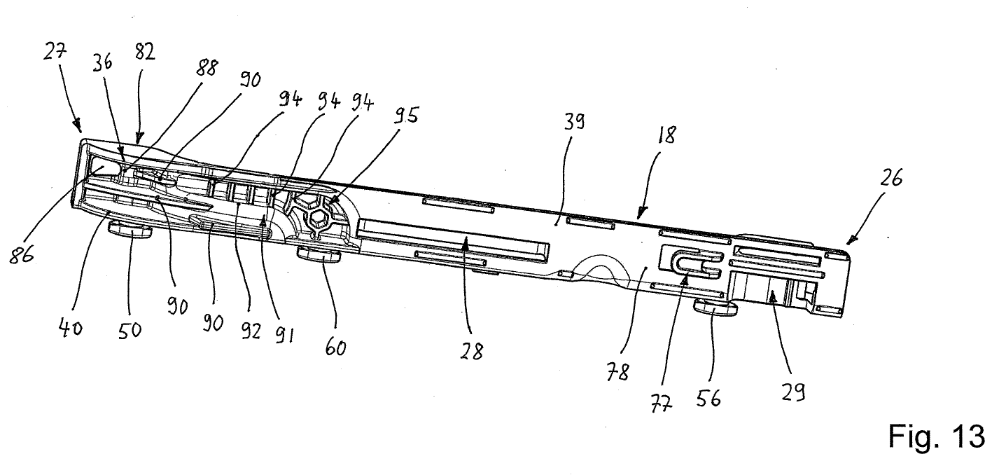

The fastening portion 82 includes a suspension opening 86 (FIGS. 12 and 13), which is formed in an upper wall 87 of the fastening portion 82, as well as a suspension web 88 that delimits the suspension opening 86 and on which the suspended deployment spring 22 is supported. The upper wall 87 is arranged on the side wall 40 with a vertical offset with respect to the upper edge 65 of the side wall 40. The distance of the suspension opening 86 and of the suspension web 88 from the side wall 40, as well as the vertical offset of the upper edge 87, are matched to the size of the deployment spring 22 and, in particular, its diameter. This design of the fastening portion 82 is thus matched to the bearing component 18 to enable the deployment spring 22 to be accommodated in a space-saving manner.

The suspension web 88 supporting the force of the deployment spring 22 is arranged, in the longitudinal direction of the bearing component 18, approximately at the height of the form-closure element 50 of the rear form-closure unit 47. This design minimizes a bending moment when the spring force is supported, via the form-closure element 50, onto the web 42.

Furthermore, the bearing component 18 has at least one reinforcing rib 89, and expediently a plurality of reinforcing ribs 89 (FIGS. 12 and 14), which connect the upper wall 87 of the fastening portion 82 to the side wall 40, and which are arranged next to one another. Such reinforcing ribs 89 reinforce and stiffen the bearing component 18 in the region of the fastening portion 82.

As a further component reinforcement or support structure, the bearing component 18 has, for example, two longitudinal ribs 90 (FIG. 13), which reinforce the fastening portion 82 on its inner side or underside and support the spring force on the bearing component 18 in the longitudinal direction.

The bearing component 18 additionally has a support elevation 91 (FIGS. 12 to 14), which extends in the longitudinal direction from the fastening portion 82 forward to the first bearing 28. The support elevation 91 has on the upper side an outer wall 92 that covers a downwardly open structure of the support elevation 91 at such a height that sufficient space remains for the deployment spring 22 arranged above it. The outer wall 92 is integrally formed onto the side wall 40, the base wall 39 and a front wall 93 of the fastening portion 82. The support elevation 91 can thus also support the spring force on the bearing component 18. The support elevation 91 has an underside or inner-side component reinforcement in the form of a plurality of transverse ribs 94, which reinforce the underside of the outer wall 92. Additionally provided is a ribbed structure 95, having a plurality of interconnected ribs, which forms a longitudinal and transverse reinforcement on the inner side or underside of the support elevation 91 in its front region. The ribbed structure 95 stiffens the support elevation 91 and thus the bearing component 18 expediently in the region of the form-closure element 60 of the third, middle form-closure unit 49. This ensures reliable dissipation of the spring force via also this form-closure element 60 onto the web 42.

In the mounting of the bearing component 18, the bearing arm 16 and the deployment lever 21 are attached to the assigned bearings 28 and 29, respectively, of the bearing arm 18. The deployment spring 22 may be fastened to the bearing component 18 and the bearing arm 16 both before mounting of the bearing component 18 and after it has been installed.

### LIST OF REFERENCE DESIGNATIONS

1 vehicle
2 vehicle roof
3 cover
4 roof opening
5 rear edge
6 roof surface
7 roof system frame
8 front region
9 front cover bearing unit
10 guide rail
11 rear cover bearing unit
12 frame part
13 front edge
14 wind deflector device
15 wind deflector bracket
16 bearing arm
17 pivot bearing means
18 bearing component
19 roof component
20 deployment means
21 deployment lever
22 deployment spring
23 wind deflector mesh
24 mesh base strip
25 frame transverse part
26 front end
27 rear end
28 first bearing
29 second bearing
30 middle region
31 bearing guide
32 bearing guide
33 rear end
34 rear end
35 front end
36 fixing means
37 fixing means
38 slideway
39 base wall
40 side wall
41 bearing component receiver
42 web
43 guideway
44 outer side
45 inner side
46 form-closure means
47 first form-closure unit
48 second form-closure unit
49 third form-closure unit
50 form-closure element
51 pin
52 pin head
53 form-closure receiver
54 longitudinal guide
55 insertion opening
56 form-closure element
57 form-closure receiver
58 longitudinal guide
59 insertion opening
60 form-closure element
61 form-closure receiver
62 longitudinal guide
63 insertion opening
64 latching element
65 upper edge
66 upper edge
67 latching recess
68 end face
69 latching engagement face
70 edge
71 deformation region
72 recess
73 front portion
74 rear portion
75 bevel
76 actuating contour
77 locking hook
78 underside
79 hook end
80 locking opening
81 frame base
82 fastening portion
83 inner side
84 outer wall
85 edge
86 suspension opening
87 upper wall
88 suspension web
89 reinforcing rib
90 longitudinal rib
91 support elevation
92 outer wall
93 front wall
94 transverse rib
95 ribbed structure
96 form-closure unit

1. A vehicle roof comprising:
an exposable roof opening and comprising a wind deflector device, assigned to the roof opening, which comprises a wind deflector bracket having lateral bearing arms and a respective deployment means that includes one of the two bearing arms,
the deployment means being pivotably carried on a pivot bearing means located on the roof and carrying the wind deflector bracket for pivoting between a pivoted-down non-operated position and a pivoted-out operated position,
wherein the pivot bearing means has a bearing component on which the deployment means is carried, the bearing component is arranged on a roof component and is fitted to a bearing-component receiver of the roof component, and the bearing component is held on the bearing-component receiver by a form-closure means.

2. The vehicle roof as claimed in claim 1, wherein the form-closure means has at least two form-closure units, each form-closure unit comprising a form-closure element on the bearing component and a form-closure receiver, assigned to this form-closure element, on the bearing-component receiver.

3. The vehicle roof as claimed in claim 2, wherein the bearing component is arranged, in the longitudinal orientation, on the bearing-component receiver of the roof component extending laterally along the roof opening, and the at least two form-closure elements and the respectively assigned form-closure receivers are mutually spaced in the longitudinal orientation of the bearing component and in the longitudinal orientation of the bearing-component receiver.

4. The vehicle roof as claimed in claim 2, wherein the first form-closure element is arranged in the region of the rear end of the bearing component and the first form-closure receiver assigned to this first form-closure element has a first longitudinal guide on the bearing-component receiver, in which the first form-closure element inserted therein is formed for a longitudinal displacement of the bearing component along the longitudinal guide, as well as for a vertical pivoting of the bearing component, and the second form-closure element is arranged on the bearing component in front of the first form-closure element in the longitudinal direction, and the second form-closure receiver assigned to this second form-closure element has a second longitudinal guide on the bearing-component receiver, in which the second form-closure element inserted therein is received so as to be displaceable longitudinally.

5. The vehicle roof as claimed in claim 2, wherein at least one of the form-closure elements is designed in such a way that, when in engagement on the assigned form-closure receiver, it holds the bearing component positioned on the bearing-component receiver in the transverse direction or y-direction.

6. The vehicle roof as claimed in claim 2, wherein the bearing-component receiver includes a web, which extends in an upright position along the roof component and on which the form-closure receivers are formed.

7. The vehicle roof as claimed in claim 2, wherein the form-closure means has a latching element, arranged on the bearing component, which is in latching engagement in a latching recess of the bearing-component receiver, or of the web, and holds the bearing component positioned in the longitudinal orientation or x-direction on the bearing-component receiver, or on the web.

8. The vehicle roof as claimed in claim 7, wherein the latching element is arranged in an elastically deformable deformation region of the bearing component and can be released from its latching engagement by elastic deformation of this deformation region in the transverse direction or y-direction.

9. The vehicle roof as claimed in claim 8, wherein the bearing component includes, on its deformation region, an actuating contour for engagement of an actuating tool that causes the deformation.

10. The vehicle roof as claimed in claim 1, wherein the bearing component has a bearing for the bearing arm, a bearing for a deployment lever, and a fixing means for a deployment spring.

11. The vehicle roof as claimed in claim 1, wherein the form-closure means has a further form-closure unit having a hook-shaped form-closure element, which is arranged on an underside of the bearing component, and in the locking position engages behind an assigned form-closure receiver on a frame base of the bearing-component receiver and holds the bearing component fixed on the bearing-component receiver in the vertical direction or z-direction.

12. The vehicle roof as claimed in claim 1, wherein the elongate bearing component has a vertical side wall and a horizontal base wall, and the bearings for the deployment means are formed and/or supported predominantly or entirely on the base wall.

13. The vehicle roof as claimed in claim 12, wherein the form-closure elements of the form-closure units assigned to the web of the bearing-component receiver are arranged on the side wall of the bearing component, and the form-closure element of the form-closure unit assigned to a frame base of the bearing-component receiver is arranged on the base wall of the bearing component.

14. The vehicle roof as claimed in any one of claim 1, wherein the bearing component has a component reinforcement or support structure, which includes a plurality of ribs and supports a fastening portion that includes the fixing means for the deployment spring.

15. The vehicle roof as claimed in claim 12, wherein the bearing component has the base wall in a front region and in a middle region, and a rear region of the bearing component is formed as a downwardly open support structure for the fastening portion of the deployment spring that includes the fixing means.

16. A method for mounding a wind deflector device on a vehicle roof as claimed in claim 1, which comprises the steps:
a) attaching and supporting the deployment means on the bearing component, the deployment spring,
during this first mounting step or
following the mounting of the bearing component into its installed position,
being clamped between the bearing component and the bearing arm,
b) mounting the bearing component on the bearing-component receiver, in that the bearing component in a first mounting position contacts the bearing-component receiver by means of the first form-closure unit,
c) performing a mounting movement that includes a pivot movement of the bearing component and by which the bearing component contacts the bearing-component receiver by means of at least one further form-closure unit, and
d) performing a mounting movement by which the bearing component is guided, in a longitudinal movement guided relative to the bearing-component receiver, into its installed position and the form-closure units thereby activate their respective form-closure engagement.
